(19) United States
(12) Patent Application Publication
(10) Pub. No.: US 2009/0032663 A1
(43) Pub. Date: Feb. 5, 2009

(54) Sucker Assembly

(76) Inventor: Eagle Fan, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/830,853

(22) Filed: Jul. 31, 2007

(51) Int. Cl. F16B 47/00

(52) U.S. Cl. 248/309.3

(57) ABSTRACT

A sucker assembly is provided, including a suction unit and a decorative unit. The decorative unit is engaged to, but not fixed, the central area of the bottom of the suction unit. The decorative unit can be rotated to detached-and-reattached for adjusting the orientation of decorative unit with respect to suction unit. The bottom surface of decorative unit includes a decorative pattern, which can be displayed to cover the bottom of the suction unit when the sucker is attached to a transparent and smooth surface.

### FIELD OF THE INVENTION

The present invention generally relates to a sucker assembly, and more specifically to a sucker assembly with an element to display a decorative pattern or commercial identification.

### BACKGROUND OF THE INVENTION

The supportive rod with sucker is an auxiliary supportive rod used in a vehicle, and is convenient for temporarily holding portable electronic devices without permanent change to the interior design of the vehicle. The supportive rod with sucker uses the sucker for attaching to the wind shield of the vehicle, and uses a rod structure to hold the electronic device to the sucker so that the electronic device is attached to the wind shield through the rod structure and the sucker. However, when viewed from the outside of the vehicle, the bottom shape of the sucker is clearly seen on the wind shield, which may not always meet the esthetic taste of the drivers. This is because most of the suction unit of the suckers is made of transparent material; therefore, the linkage structure between the suction unit and the part structural element can be clearly seen. In addition, the suction unit includes a plurality of protruding ribs to enhance the structure. In short, the shape of the bottom of the suction unit is far from decorative esthetics, and an enhancement is beneficial.

### SUMMARY OF THE INVENTION

The primary object of the present invention is to provide an improved sucker assembly that is esthetic, by including a decorative unit at the bottom of the suction unit to cover the bottom of the suction unit. The exposed surface of the decorative unit forms a pattern, or includes an auxiliary pad. The auxiliary pad can be a sticker with decorative patterns, such as logo. When the suction unit is attached to the wind shield, the decorative pattern auxiliary pad, instead of the shape of the bottom of the suction unit, can be seen from outside.

Another object of the present invention is to provide an improved sucker assembly that is practical. The decorative pattern on the decorative unit must be placed correctly; however, as the position and the orientation of the suction unit may be placed differently, the decorative patterns may be tilted because of the suction unit. Therefore, the decorative unit, while attached to the bottom of the suction unit, can still rotate to adjust the orientation so that the decorative pattern can be correctly displayed to achieve the practical and esthetical purposes.

To achieve the above objects, the present invention provides a sucker assembly, including a suction unit and a decorative unit. The decorative unit is attached to the central area of the bottom of the suction unit, but not completely fixed. The decorative unit can be rotated or detached-and-reattached for angle adjustment. The maximum diameter and the thickness of the decorative unit are both less than the suction unit, and a gap exists between the circumference of the decorative unit and the circumference of the bottom of the suction unit. The exposed surface of the decorative unit forms a decorative pattern.

When the suction unit of the present invention is attached to a glass or other smooth surface, the suction disc of the suction unit is tightly attached to the glass. The central area of the suction disc is pulled away from the glass so that a gap forms at the central area between the suction unit and the glass and a negative pressure is formed to achieve the tight attachment effect. Therefore, the decorative unit of the present invention attached to the central area of the suction unit will not affect the tight attachment effect of the design.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the first embodiment of the present invention;

FIG. 2 shows a schematic view of the second embodiment of the present invention;

FIG. 3 shows a dissected view of the first embodiment of FIG. 1;

FIG. 4 shows a schematic view of the decorative unit from a different angle;

FIG. 5 shows a cross-sectional view of the first embodiment of FIG. 1;

FIG. 6 shows a schematic view of the third embodiment of the present invention; and

FIG. 7 shows a schematic view of the fourth embodiment of the present invention.

### DETAILED DESCRIPTION OF THE PREFERRED EMBODIMENTS

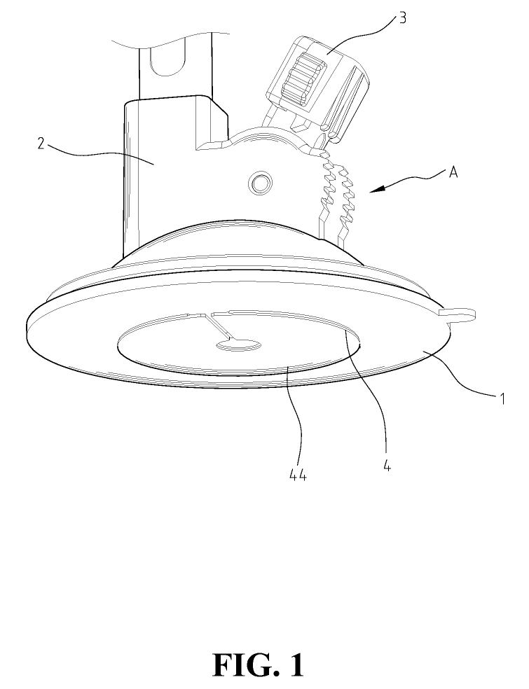

The present invention is to improve the suction unit of the conventional supportive rod with sucker. FIG. 1 shows a sucker A, including a suction unit 1, a base seat unit 2, and a pull unit 3. Suction unit 1 is a round disc made of elastic material. Base seat unit 2 includes a dome with a flat circular band for supporting suction unit 1 and a protruding rod seat for the supportive rod (not shown) to hold the electronic device. The dome and the flat circular band form the shape of a saucer. The protruding rod seat is located at the top part of the dome for connecting the supportive rod. Pull unit 3 is located on top of the dome of base seat unit 2, including linkage mechanism to pull suction unit 1. To use sucker assembly A, the first step is to press suction unit 1 to a smooth surface, and then pull the pull unit 3. The flat circular band of the dome of base seat 2 tightly presses the outer part of suction unit 1 against the smooth surface. The central area of suction unit 1 is pulled away from the smooth surface by pull unit 3 so that a gap is formed between the central area of suction unit 1 and the smooth surface; thus a negative pressure is formed to achieve the tight attachment effect. There are numerous types of the sucker assembly, and the above embodiment is just one type. The sucker assembly of the present invention improves the structure of suction unit 1, and is applicable to different types of suckers. The top part of suction unit 1 is to match the sucker, and is similar to the conventional design. Therefore, the detailed description of the top part of suction unit 1 is omitted.

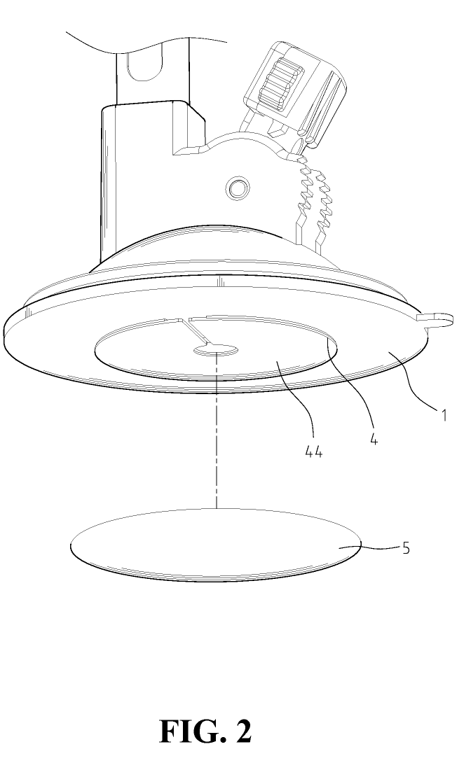

As shown in FIG. 1, the sucker assembly of the present invention includes a suction unit 1 and a decorative unit 4. Decorative unit 4 is engaged to the central area of the bottom of suction unit 1 to cover the bottom of suction unit 1. The maximum diameter and the thickness of the decorative unit 4 are both less than those of suction unit 1. A gap exists between the edge of decorative unit 4 and the edge of suction unit 4. Bottom surface 44 of decorative unit 4 has a decorative pattern, which may be printed on bottom surface 44. FIG. 2 shows an auxiliary pad 5 is used on bottom surface 44 of decorative unit 4. Auxiliary pad 5 can be a sticker, and the decorative pattern can even include slight convex bumps to make the pattern more three-dimensional. Decorative unit 4 is not completely fixed to suction unit 1. On the other hand, decorative unit 4 can be rotated, or detached-and-reattached for angle adjustment so that the decorative pattern can be correctly oriented.

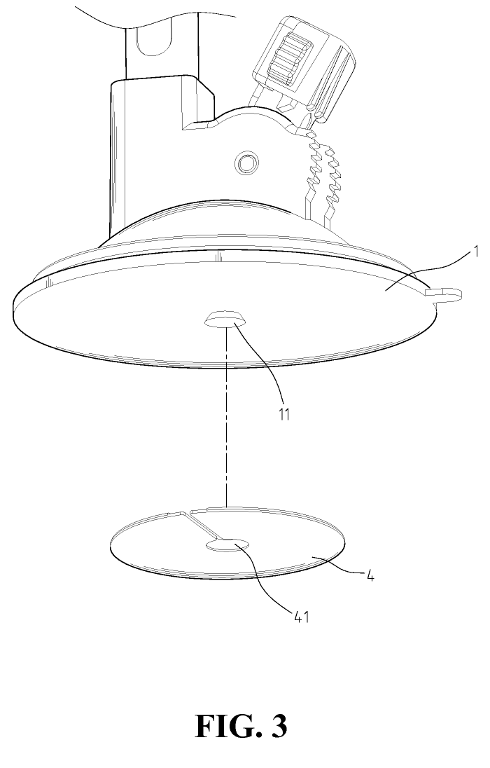

FIG. 3 shows a dissected view of the present invention. Suction unit 1 is a suction disc made of elastic material, and has a protruding part 11. Protruding part 11 is located at and protruding from the central area of the bottom of suction unit 1. Protruding part 11 has the shape of a cone with the smaller diameter end attached to the bottom of suction unit 1. Decorative unit 4 is a round plate with an engaging groove 41. Engaging groove 41 is located at the central area of decorative unit 4, and is a penetrating conic hole. The size of engaging groove matches the size of protruding part 11 of suction unit 1. When protruding part 11 is engaged to engaging groove 41, decorative unit 4 is attached to the bottom of suction unit 1, rotatable but not disengaged easily.

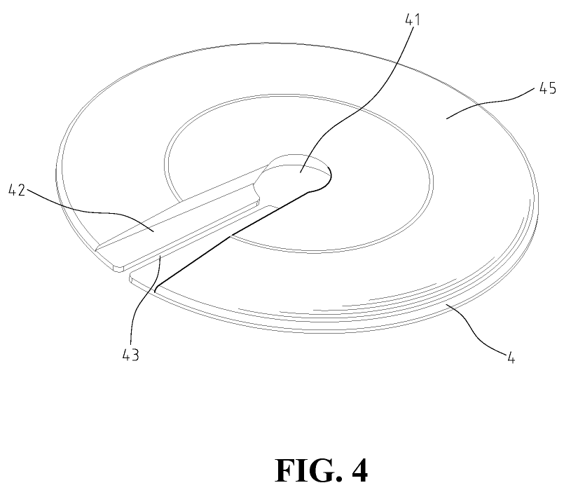

As shown in FIG. 4, to facilitate the attachment of decorative unit 4 to suction unit 1, decorative unit 4 further includes a guiding groove 42 and an auxiliary groove 43. Guiding groove 42 is formed on the top surface 45 of decorative unit 4 in the radius orientation, and is connected to engaging groove 41. The width of groove at the location where guiding groove 42 and engaging groove are connected is less than the minimum outer radius of engaging groove 41. Auxiliary groove 43 is inside guiding groove 42. Auxiliary groove 43 is hole penetrating decorative unit 4, and is connected to engaging groove 41. Therefore, decorative unit 4 is slightly expansive outward so that protruding part 11 can be inserted more easily into engaging groove 41 through guiding groove 42.

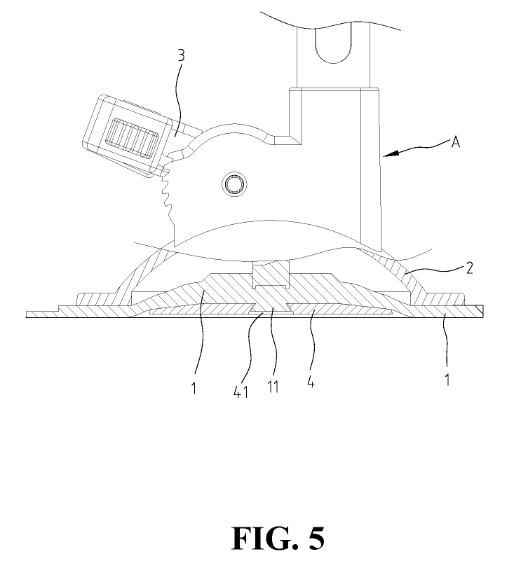

FIG. 5 shows a schematic view of the present invention in actual use. When sucker A is in use, the linkage mechanism of pull unit 3 will pull the central area of suction unit 1 away from the smooth surface. Although decorative unit 4 is located at the central area of the bottom of suction unit 1, decorative unit 4 will not affect the attachment of suction unit 1 to the smooth surface. The decorative pattern of decorative unit 4 will covers the bottom of suction unit 1, and can be seen from outside of the glass or wind shield.

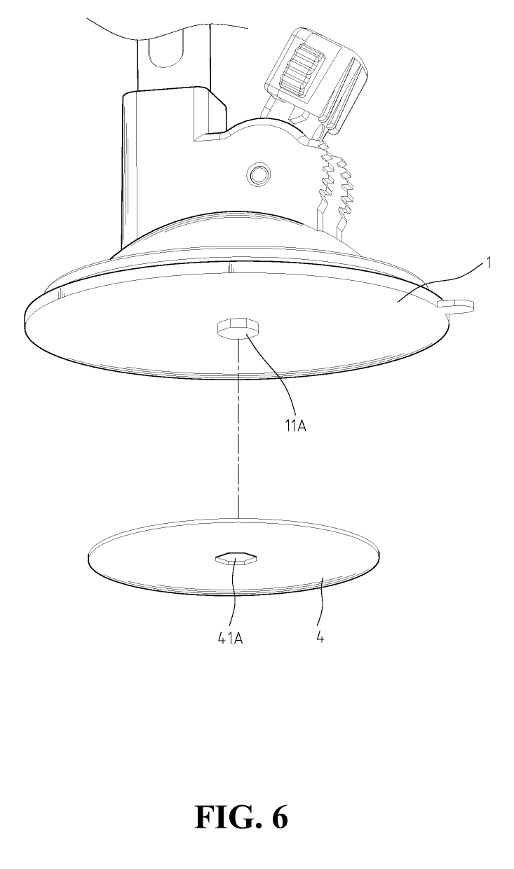

FIG. 6 shows the third embodiment of the present invention. In this embodiment, the shapes of protruding part 11A and engaging groove 41A are different. In this embodiment, protruding part 11A is a polygon and protrudes from the bottom surface of suction unit 1. Engaging groove 41A, on the other hand, is has the shape of a matching polygon, with size slightly larger than protruding part 11A. When in use, protruding part 11A is inserted in engaging groove 41A so as to maintain the relative position of decorative unit 4 and suction unit 1. Similarly, decorative unit 4 can be detached and reattached to suction unit 1 for angle adjustment so that the decorative pattern will be displayed in correct orientation. Therefore, the protruding part of the present invention is not limited to the conic shape. Other shapes of protruding parts can also be used as long as matching shapes of engaging groove is used.

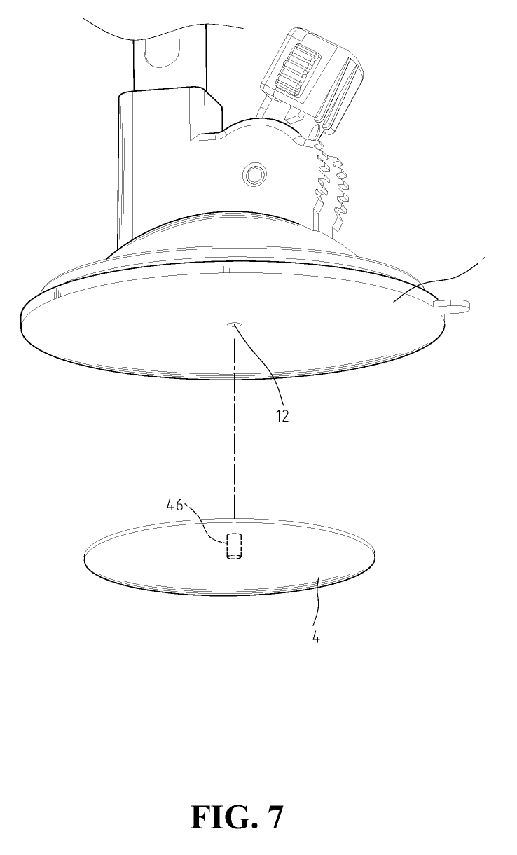

In the above description, the present invention includes a protruding part in the suction unit, and an engaging groove in the decorative unit so that the decorative unit can be engaged to the bottom of the suction unit. However, as the fourth embodiment shown in FIG. 7, the embodiment includes a concave engaging groove 12 at the central area of the bottom of suction unit 1, and a protruding part 46 of decorative unit 4. Protruding part 46 matches the shape of engaging groove 12. When protruding part 46 is engaged to engaging groove 12, decorative unit 4 is engaged to suction unit 1. The angle adjustment function is also available in this embodiment.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A sucker assembly, comprising:
a suction unit, having a disc shape; and
a decorative unit, engaged to the central area of the bottom of said suction unit, said decorative unit being not fixed to said suction unit, said decorative unit able to adjust orientation with respect to said suction unit, said decorative unit having maximum diameter and thickness less than said suction unit, and a gap existing between the edge of said decorative unit and the edge of the bottom of said suction unit.

2. The sucker assembly as claimed in claim 1, wherein the bottom surface of said decorative unit forms a decorative pattern.

3. The sucker assembly as claimed in claim 1, wherein an auxiliary pad is attached to the bottom surface of said decorative unit, said auxiliary pad is a sticker or thin film with decorative pattern.

4. The sucker assembly as claimed in claim 1, wherein said orientation adjustment between said decorative unit and suction unit is accomplished by direct rotation.

5. The sucker assembly as claimed in claim 1, wherein said orientation adjustment between said decorative unit and suction unit is accomplished by detaching said decorative unit from said suction unit, rotating said decorative unit for an angle, and reattaching said decorative unit to said suction unit.

6. The sucker assembly as claimed in claim 1, wherein said suction unit has a protruding part located at the central area and protruding from the bottom surface, said decorative has an engaging groove located at the central area and is for engaging said protruding part so that said decorative unit is engaged to said suction unit at the central area.

7. The sucker assembly as claimed in claim 6, wherein said protruding part is conic with smaller diameter end attaching to said suction unit, said engaging groove of said decorative unit is also conic and matches said protruding part, and when said protruding part is engaged to said engaging groove, said decorative unit can rotate while stay attached to said suction unit.

8. The sucker assembly as claimed in claim 6, wherein said decorative unit further comprises a guiding groove and an auxiliary groove, said guiding groove is formed on the top surface of said decorative unit in the radius orientation, and is connected to said engaging groove, the width of groove at the location where said guiding groove and said engaging groove are connected is less than the minimum outer radius of said engaging groove, said auxiliary groove is inside said guiding groove, said auxiliary groove is a hole penetrating said decorative unit, and is connected to said engaging groove so that said decorative unit is slightly expansive outward and elastic.

9. The sucker assembly as claimed in claim 6, wherein the shape of said protruding part is polygonal, and the shape of said engaging groove is a match polygonal.

10. The sucker assembly as claimed in claim 1, wherein said suction unit further comprises a concave engaging groove located at the central area of said suction unit, said decorative unit further comprises a protruding part, located at the central area of said decorative part, and said decorative unit is engaged to said suction unit when said protruding part is inserted in said engaging groove after assembled.
